(19) United States
(12) Patent Application Publication
(10) Pub. No.: US 2024/0079748 A1
(43) Pub. Date: Mar. 7, 2024

(54) BATTERY CELL, AND BATTERY MODULE AND BATTERY PACK INCLUDING THE SAME

(71) Applicant: SK On Co., Ltd., Seoul (KR)

(72) Inventors: Jae Sik SHIN, Daejeon (KR); Seung Hoon JU, Daejeon (KR); Jae Gyu BYUN, Daejeon (KR); Gi Jeong SEO, Daejeon (KR); Dong Ha HWANG, Daejeon (KR)

(21) Appl. No.: 18/453,314

(22) Filed: Aug. 22, 2023

(30) Foreign Application Priority Data
Sep. 7, 2022 (KR) 10-2022-0113657
May 26, 2023 (KR) 10-2023-0068606

(51) Int. Cl. H01M 50/567; H01M 50/188; H01M 50/593

(52) U.S. Cl. CPC H01M 50/567; H01M 50/188; H01M 50/593

(57) ABSTRACT

In some implementations, is provided a battery cell, and battery module and battery pack including the same including: an electrode assembly in which a plurality of polar plates are stacked; a case having an internal space in which the electrode assembly is accommodated; a cap assembly coupled to the case and having a terminal disposed therein; and a connection pin configured to electrically connect the electrode assembly and the terminal, wherein the terminal includes: a rivet having an insertion hole into which the connection pin is inserted; and a terminal portion coupled to the rivet.

### CROSS-REFERENCE TO RELATED APPLICATION(S)

This patent document claims the priority and benefits of Korean Patent Application Nos. 10-2022-0113657 and 10-2023-0068606 filed on Sep. 7, 2022, and May 26, 2023, the disclosures of which are incorporated herein by reference in their entirety.

### TECHNICAL FIELD

The technology and implementations disclosed in this patent document generally relate to a battery cell, and a battery module and a battery pack including the same.

### BACKGROUND

FIG. 1 is a reference diagram illustrating a structure in which an electrode assembly EA is connected to an electrode terminal ET in a conventional battery cell BC.

The battery cell BC may include the electrode assembly EA, a housing HS in which the electrode assembly EA is accommodated, and a cap assembly CA coupled to the housing HS.

The electrode assembly EA may be electrically connected to an electrode terminal ET of the cap assembly CA. The electrode assembly EA and the electrode terminal ET may be connected to each other through a connection member CM disposed therebetween. For example, referring to FIG. 1, one side of the connection member CM may be electrically connected to the electrode assembly EA, and the other side of the connection member CM may be electrically connected to the electrode terminal ET of the cap assembly CA.

At least a portion of the connection member CM may be bent. For example, the connection member CM may be bent in a substantially C-shape or a substantially S-shape between the electrode assembly EA and the cap assembly CA. In order to easily bend the connection member CM, the connection member CM may have a thin metal line or a metal plate shape.

According to the connection structure, the connection member CM occupies a predetermined space between the electrode assembly EA and the electrode terminal ET. Accordingly, a space in which the electrode assembly EA may be accommodated in an internal space of the housing HS may be reduced, which may cause the energy density of the battery cell BC to be reduced.

Furthermore, there may be a concern in that the connection member CM may be damaged or a connection region may be broken during an assembly process of the cap assembly CA.

Furthermore, since it may be difficult to connect the connection member CM after the cap assembly CA is coupled to the housing HS to close the internal space of the housing HS, it is necessary to connect the connection member CM to the electrode assembly EA and the electrode terminal ET, respectively, before coupling the cap assembly CA to the housing HS. Accordingly, there may be a concern in that a manufacturing process of the battery cell BC may become complicated, and production costs may increase.

### SUMMARY

The disclosed technology can be implemented in some embodiments to provide a battery cell having a connection structure in which an electrode assembly and an electrode terminal can be simply and stably connected to each other, and a battery module and a battery pack including the same.

Furthermore, an aspect of the present technology is to provide a battery cell configured to increase energy density, and a battery module and a battery pack including the same.

Furthermore, an aspect of the present technology is to provide a battery cell configured to simplify an assembly process, and a battery module and a battery pack including the same.

A battery cell according to the disclosed technology includes: an electrode assembly in which a plurality of polar plates are stacked; a case having an internal space in which the electrode assembly is accommodated; a cap assembly coupled to the case and having a terminal disposed therein; and a connection pin configured to electrically connect the electrode assembly and the terminal, wherein the terminal includes: a rivet having an insertion hole into which the connection pin is inserted; and a terminal portion coupled to the rivet.

In some embodiments of the disclosed technology, the terminal portion and the rivet are formed of different materials.

In some embodiments of the disclosed technology, the rivet and the connection pin are formed of the same material.

In some embodiments of the disclosed technology, the cap assembly further includes: a cap plate coupled to at least one side of the case to support the terminal portion; and a sealing member disposed between the cap plate and the rivet.

In some embodiments of the disclosed technology, the cap assembly further includes: a first insulating member disposed between the cap plate and the terminal portion.

In some embodiments of the disclosed technology, the battery cell includes: a current collecting member electrically connected to the connection pin, wherein the electrode assembly further includes an uncoated portion electrically connected to the current collecting member.

In some embodiments of the disclosed technology, the uncoated portion includes a bent portion in contact with the current collecting member, and the bent portion is disposed between the current collecting member and the terminal.

In some embodiments of the disclosed technology, the bent portion includes an avoiding portion for avoiding the connection pin.

In some embodiments of the disclosed technology, an end of the rivet is inserted into the avoiding portion.

In some embodiments of the disclosed technology, the rivet includes a guide groove for guiding an insertion position of the connection pin.

In some embodiments of the disclosed technology, an end of the connection pin is exposed to the outside of the cap assembly through the insertion hole.

A battery cell according to the disclosed technology includes: a case including a first opening and a second opening spaced apart from the first opening; an electrode assembly accommodated in the case; a first cap assembly coupled to the first opening and including a first terminal; a second cap assembly coupled to the second opening and including a second terminal; and a first connection pin configured to electrically connect the first terminal and the electrode assembly.

In some embodiments of the disclosed technology, the first terminal includes: a first rivet having a first insertion hole into which the first connection pin is inserted; and a first terminal portion coupled to the first rivet.

In some embodiments of the disclosed technology, the first rivet and the first terminal portion are formed of different materials.

In some embodiments of the disclosed technology, the first cap assembly includes: a first cap plate coupled to the first opening of the case above to support the first terminal portion; and a first insulating member configured to electrically separate the first cap plate from the first terminal portion.

In some embodiments of the disclosed technology, the battery cell further includes: a second connection pin configured to electrically connect the second terminal and the electrode assembly, wherein the second terminal includes: a second rivet having a second insertion hole into which the second connection pin is inserted; and a second terminal portion coupled to the second rivet.

In some embodiments of the disclosed technology, the first connection pin and the second connection pin are formed of different materials, the first rivet includes the same material as that of the first connection pin, and the second rivet includes the same material as that of the second connection pin.

In some embodiments of the disclosed technology, the first terminal portion and the second terminal portion are formed of the same material.

In some embodiments of the disclosed technology, the second cap assembly further includes: a second cap plate coupled to the second opening of the case to support the second terminal portion, and the second terminal portion is in contact with the second cap plate.

In some embodiments of the disclosed technology, the first connection pin and the second connection pin are welded and coupled to the first rivet and the second rivet, respectively.

In some embodiments of the disclosed technology, the first cap assembly is coupled to one side of the case, and the second cap assembly is coupled to the other side, opposite to the one side of the case.

A battery module according to the disclosed technology includes: at least one battery cell, wherein the battery cell includes: an electrode assembly in which a plurality of polar plates are stacked; a case having an internal space in which the electrode assembly is accommodated; a cap assembly coupled to the case and having a terminal disposed therein; and a connection pin configured to electrically connect the electrode assembly and the terminal, wherein the terminal includes: a rivet having an insertion hole into which the connection pin is inserted; and a terminal portion coupled to the rivet.

A battery pack according to the disclosed technology includes: at least one battery cell, wherein the battery cell includes: an electrode assembly in which a plurality of polar plates are stacked; a case having an internal space in which the electrode assembly is accommodated; a cap assembly coupled to the case and having a terminal disposed therein; and a connection pin configured to electrically connect the electrode assembly and the terminal, wherein the terminal includes: a rivet having an insertion hole into which the connection pin is inserted; and a terminal portion coupled to the rivet.

A battery cell, and a battery module and a battery pack including the battery cell according to embodiments may stably connect an electrode assembly and a terminal through a connection assembly capable of ensuring connection stability as well as structural conciseness.

Furthermore, a battery cell, and a battery module and a battery pack including the battery cell according to embodiments, include a connection assembly in which at least a portion thereof is inserted into a terminal, thereby reducing wasted space inside a case to increase energy density.

Furthermore, a battery cell, and a battery module and a battery pack including the battery cell according to embodiments may simplify an assembly process because a connection assembly is electrically connected to a terminal in the process of attaching a cap assembly to a case.

### BRIEF DESCRIPTION OF DRAWINGS

Certain aspects, features, and advantages of the disclosed technology are illustrated by the following detailed description with reference to the accompanying drawings.

FIG. 1 is a reference view illustrating a structure in which an electrode assembly is connected to an electrode terminal in a conventional battery cell.

FIG. 2 is a perspective view of a battery cell according to embodiments.

FIG. 3 is an exploded perspective view of a battery cell according to embodiments.

FIG. 4 is an exploded perspective view of a battery cell viewed from a different angle from FIG. 3.

FIG. 5 is an exploded perspective view of a first cap assembly.

FIG. 6 is an exploded perspective view of a second cap assembly.

FIG. 7 is a view exemplarily illustrating a state in which an electrode assembly and a connection assembly are coupled to each other.

FIG. 8 is a view exemplarily illustrating a state in which a cap assembly is coupled to a case.

FIG. 9 is a view illustrating an example in which a first cap assembly is coupled to a case.

FIG. 10 is a partial cross-sectional view of a battery cell according to embodiments.

FIG. 11 is a partial cross-sectional view of a battery cell according to embodiments.

FIG. 12 is a perspective view of a battery module and a battery pack including the battery cell according to embodiments.

FIG. 13 is a perspective view illustrating a state in which the battery module is separated in FIG. 12.

### DETAILED DESCRIPTION

Prior to describing the exemplary embodiments in detail, it should be understood that the terms used in the specification and the appended claims should not be construed as being limited to general and dictionary meanings, but should be interpreted based on the meanings and concepts corresponding to technical aspects of the present disclosure on the basis of the principle that the inventor is allowed to define terms appropriately for the best explanation.

The same reference numeral or symbol written in each accompanying drawing of the specification refers to parts or components that perform substantially the same function. For convenience of explanation and understanding, the disclosed technology is described using the same reference numeral or symbol even in different exemplary embodiments.

In this specification, the singular also includes the plural unless specifically stated otherwise in the phrase. It will be further understood that the terms “comprises,” “comprising,” “includes” and/or “including,” when used herein, specify the presence of stated features, integers, steps, operations, elements, components and/or combinations thereof, but do not preclude the presence or addition of one or more other features, integers, steps, operations, elements, components, and/or groups thereof.

Furthermore, it should be noted in advance that the expressions such as “above,” “upper,” “below,” “beneath,” “lower,” “side,” “front,” and “rear” are based on the direction illustrated in the drawings, and may be expressed differently if the direction of the object is changed.

Furthermore, in the present specification and claims, terms including ordinal numbers such as “first” and “second” may be used to distinguish between components. These ordinal numbers are used to distinguish the same or similar components from each other, and the meaning of the terms should not be construed as limited by the use of these ordinal numbers. For example, the components combined with these ordinal numbers should not be construed as limiting the order of use or arrangement of the components. If necessary, the ordinal numbers may be used interchangeably.

Hereinafter, with reference to the drawings, specific embodiments of the disclosed technology will be described. However, this is only exemplary and the disclosed technology is not limited to the specific embodiments described as examples.

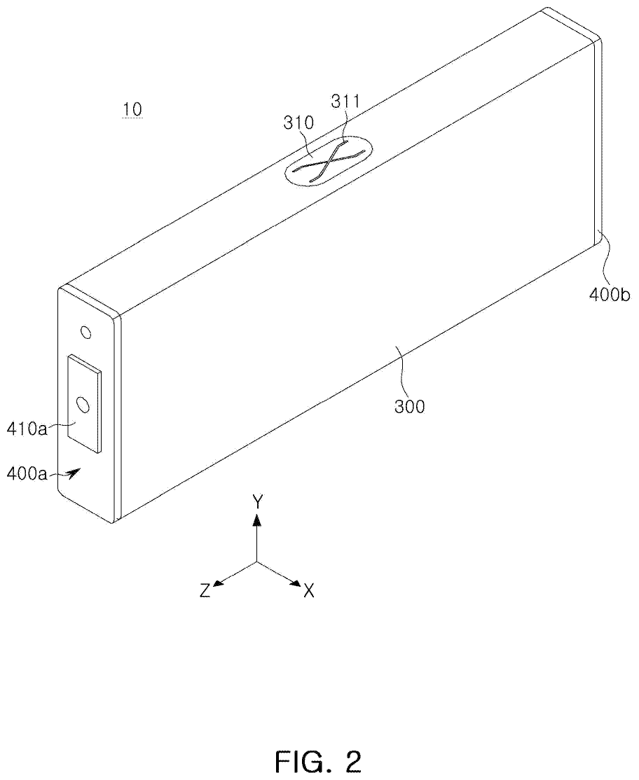

FIG. 2 is a perspective view of a battery cell 10 according to embodiments.

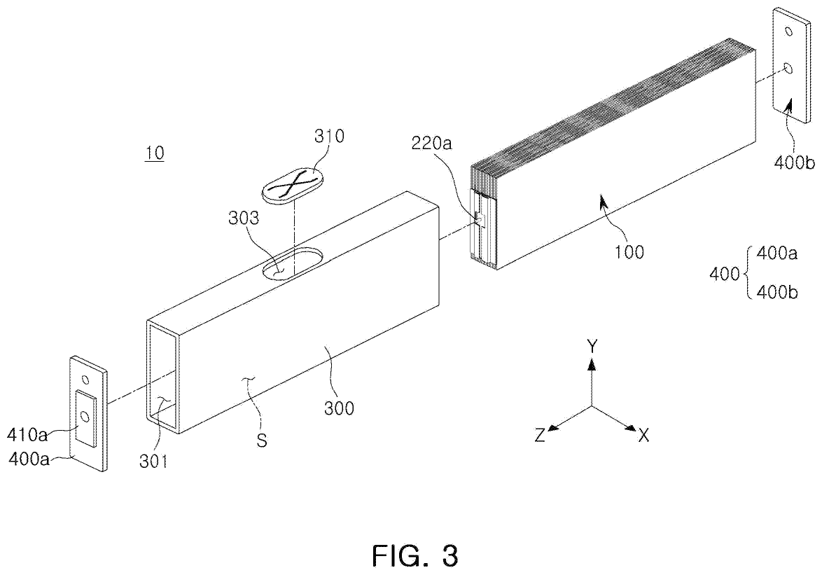

FIG. 3 is an exploded perspective view of a battery cell 10 according to embodiments.

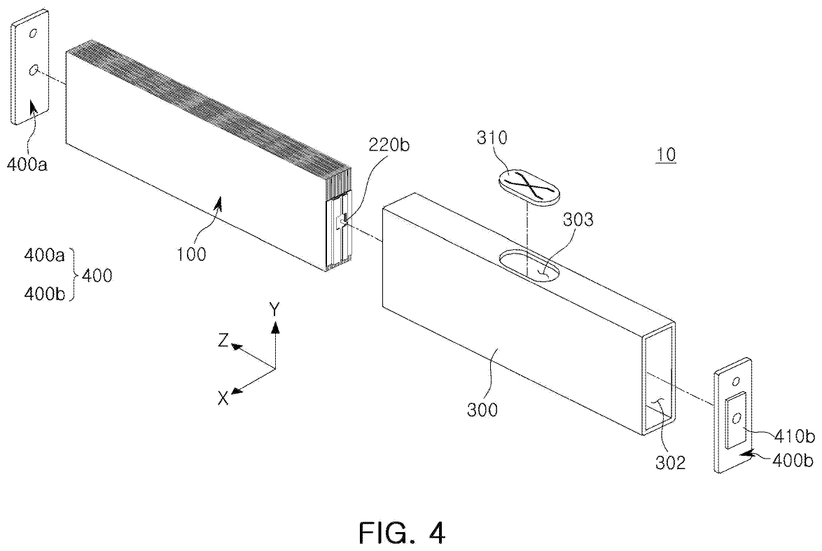

FIG. 4 is an exploded perspective view of a battery cell 10 viewed from a different angle from FIG. 3.

In some embodiments, the battery cell 10 may be a rechargeable secondary battery. The battery cell 10 may be a secondary battery having an angular appearance as illustrated in FIGS. 2 to 4, but the specific appearance thereof is not limited to those illustrated in the drawings.

In some embodiments, the battery cell 10 may include an electrode assembly 100, a case 300 having an internal space in which the electrode assembly 100 is accommodated, and one or more cap assemblies coupled to the case 300 to close the internal space of the case 300.

The electrode assembly 100 may include a plurality of polar plates and a separator disposed between the polar plates. For example, the electrode assembly 100 may be formed by stacking a plurality of positive pole plates, a plurality of negative pole plates, and one or more separators in one direction. Alternatively, the electrode assembly 100 may have a jelly roll structure in which the positive pole plate, the negative pole plate, and the separator interposed between them are wound.

In some embodiments, the battery cell 10 may include one or more electrode assemblies 100. When the battery cell 10 has a plurality of electrode assemblies, the electrode assemblies may be stacked and disposed in one direction (e.g., an X-axis direction).

The case 300 may have an internal space S in which the electrode assembly 100 and an electrolyte (not illustrated) may be accommodated.

The case 300 may include a material having sufficient rigidity to protect the internal electrode assembly 100 and maintain an external shape of the entire battery cell 10. For example, at least a portion of the case 300 may be formed of a metal material such as aluminum, iron, or stainless steel. However, the material of the case 300 is not limited thereto, and may be formed of any material as long as it has rigidity capable of maintaining the external shape of the battery cell 10 and protecting the internal electrode assembly.

The case 300 may have the internal space S and may have a shape in which at least one side thereof is open. For example, referring to FIGS. 3 and 4, the case 300 may have a hexahedral shape in which a first opening 301 and a second opening 302 are formed at both ends thereof in a longitudinal direction (e.g., a Z-axis direction). The internal space S may be formed between the first opening 301 and the second opening 302, and the electrode assembly 100 may be accommodated in the internal space S.

In the following description, embodiments will be described on the premise that the case 300 has a hexahedral shape in which both sides thereof are open, as illustrated in FIGS. 3 and 4. However, a specific shape of the case 300 is not limited to those illustrated in FIGS. 3 and 4. The case 300 may be configured in any shape as long as it secures the internal space S into which the electrode assembly 100 may be inserted and accommodated. For example, the case 300 may have a shape of a circular pillar in which an upper surface or a lower surface thereof is open, or a shape of a polyhedron in which at least one side is open.

In embodiments, the battery cell 10 may include one or more cap assemblies 400a and 400b coupled to the case 300. For example, referring to FIGS. 3 and 4, the first and second cap assemblies 400a and 400b are coupled to the first and second openings 301 and 302 of the case 300, respectively, to close the internal space S of the case 300.

Each of the cap assemblies 400a and 400b may include cap plates 420a and 420b coupled to the case 300 and terminals 410a and 410b disposed in the cap plates 420a and 420b.

The terminals 410a and 410b may be electrically connected to the electrode assembly 100 in the case 300. The electrode assembly 100 may be electrically connected to other components (e.g., a conductive busbar) outside the battery cell 10 through the terminals 410a and 410b.

The terminals 410a and 410b may be fixedly disposed on the cap plates 420a and 420b. The cap plates 420a and 420b may be coupled to the case 300 to form at least one side surface of the battery cell 10.

The cap plates 420a and 420b may include a material having a predetermined rigidity to close one open side of the case 300 and protect the electrode assembly 100 disposed in the internal space S. For example, at least a portion of the cap plates 420a and 420b may be formed of the same material as the case 300.

The cap assemblies 400a and 400b may be welded and coupled to the case 300. For example, while the cap plates 420a and 420b of the cap assembly 400a and 400b cover the openings 301 and 302 of the case 300, a portion thereof in contact with the case 300 may be laser welded to the case 300. However, a coupling method between the cap assemblies 400a and 400b and the case 300 is not limited to the aforementioned description.

In one battery cell 10, a plurality of cap assemblies 400a and 400b may be provided. For example, the cap assemblies 400a and 400b may include a first cap assembly 400a and a second cap assembly 400b in which the first terminal 410a and the second terminal 410b having opposite polarities are disposed, respectively.

As illustrated in FIGS. 3 and 4, the first cap assembly 400a and the second cap assembly 400b may be coupled to both ends of the case 300. For example, the first cap assembly 400a may have a first terminal 410a as a negative pole terminal and may be coupled and welded to the first opening 301 of the case 300 to close the first opening 301. The second cap assembly 400b may have a second terminal 410b as a positive pole terminal and may be coupled and welded to the second opening 302 of the case 300 to close the second opening 302. Accordingly, the first cap assembly 400a and the second cap assembly 400b may close both sides of the case 300 in which the electrode assembly 100 is accommodated.

A laser welding method may be applied to the coupling of the cap assembly 400 and the case 300, but a specific coupling method is not limited thereto.

However, the position of the cap assembly 400 is not limited to those illustrated in FIGS. 3 and 4. For example, unlike those illustrated in FIGS. 3 and 4, in the battery cell 10, a plurality of cap assemblies 400a and 400b may all be disposed on the same side surface of the case 300.

The battery cell 10 may include a connection assembly 200 disposed on at least one side of the electrode assembly 100 to electrically connect the electrode assembly 100 and the terminals 410a and 410b to each other.

In the battery cell 10, a plurality of connection assemblies 200 may be provided. For example, referring to FIGS. 3 and 4, the battery cell 10 may include a first connection assembly 200a disposed on one side of the electrode assembly 100 and a second connection assembly 200b disposed on the other side of the electrode assembly 100.

The connection assembly 200 may include connection pins 220a and 220b electrically connected to the electrode assembly 100.

At least a portion of the connection pins 220a and 220b of the connection assembly 200 may be inserted into the cap assembly 400. For example, the connection pins 220a and 220b may be inserted into the terminals 410a and 410b of the cap assembly 400 and may be electrically connected to the terminals 410a and 410b. Accordingly, the electrode assembly 100 may be electrically connected to the terminals 410a and 410b of the cap assembly 400 through the connection pins 220a and 220b.

The connection assembly 200 may be bonded to the electrode assembly 100 on one side of the electrode assembly 100. For example, in the electrode assembly 100, an uncoated portion on which an active material is not coated, and the connection assembly 200 may be bonded to each other. A laser welding method may be applied to the bonding of the uncoated portion and the connection assembly 200. However, in addition to a laser welding method, any bonding method may be applied as long as it can electrically connect the uncoated portion and the connection assembly 200.

The cap assembly 400 may be configured to be assembled in the opening of the case 300 in the first direction (Z-axis direction), and the connection assembly 200 may be disposed to face the cap assembly 400 in the first direction (Z-axis direction). At least a portion of the connection pin 220 may extend in the first direction and may be naturally inserted into the terminals 410a and 410b in the process of coupling the cap assembly 400 to the case 300.

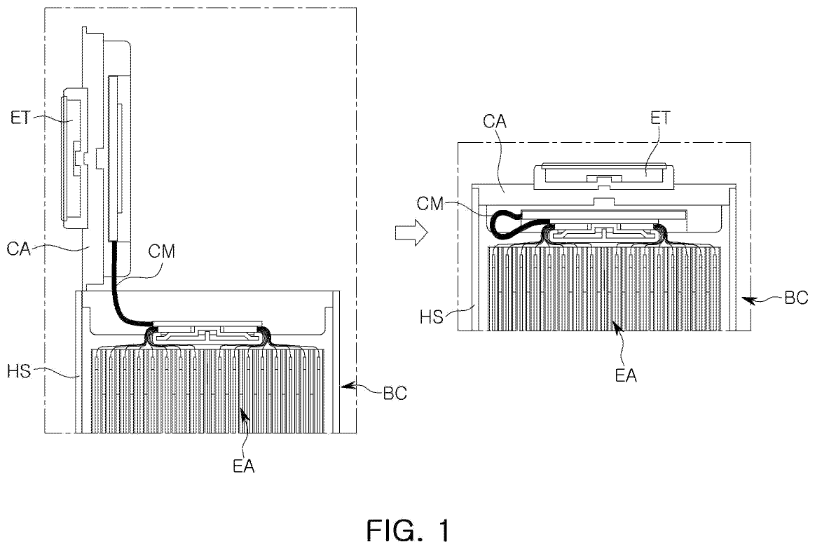

According to the battery cell 10 according to some embodiments, the electrode assembly 100 and the terminals 410a and 410b may be stably connected to each other through the connection pins 220a and 220b of the connection assembly 200. Specifically, unlike the battery cell BC illustrated in FIG. 1, the assembly process may be further simplified because the terminals 410a and 410b and the electrode assembly 100 are naturally connected to each other during the assembly process of the cap assembly 400 and the case 300. Furthermore, in the battery cell 10 according to some embodiments, since at least a portion of the connection pins 220a and 220b is inserted into the terminals 410a and 410b, it is advantageous to increase energy density by reducing wasted space for a connection between the electrode assembly 100 and the terminals 410a and 410b.

Meanwhile, the battery cell 10 may further include a vent member 310 configured to discharge gas generated in the internal space S. When the internal pressure of the battery cell 10 is higher than a predetermined pressure, the vent member 310 may be opened earlier than other regions of the battery cell 10 to prevent the battery cell 10 from exploding.

The vent member 310 may be coupled to the case 300. For example, the vent member 310 may be coupled to a venting hole 303 formed on a side surface of the case 300.

The vent member 310 may be coupled to the venting hole 303 to close the venting hole 303. When the internal pressure of the case 300 is lower than a preset pressure, the vent member 310 may be configured to seal the vent hole 303, thereby preventing foreign materials from flowing into the battery cell 10 via the venting hole 303 or an electrolyte inside the battery cell 10 from flowing out.

When gas is generated in the internal space S of the case 300 while the battery cell 10 is repeatedly charged and discharged and the internal pressure is higher than the preset pressure, at least a portion of the vent member 310 may be configured to be broken. For example, a notch portion 311 having a lesser thickness than those of other portions may be formed on the vent member 310. When the internal pressure of the case 300 is higher than the preset pressure, the notch portion 311 may be preferentially broken in the vent member 310, and the gas in the internal space S may be discharged to the outside of the battery cell 10 through the broken notch portion 311.

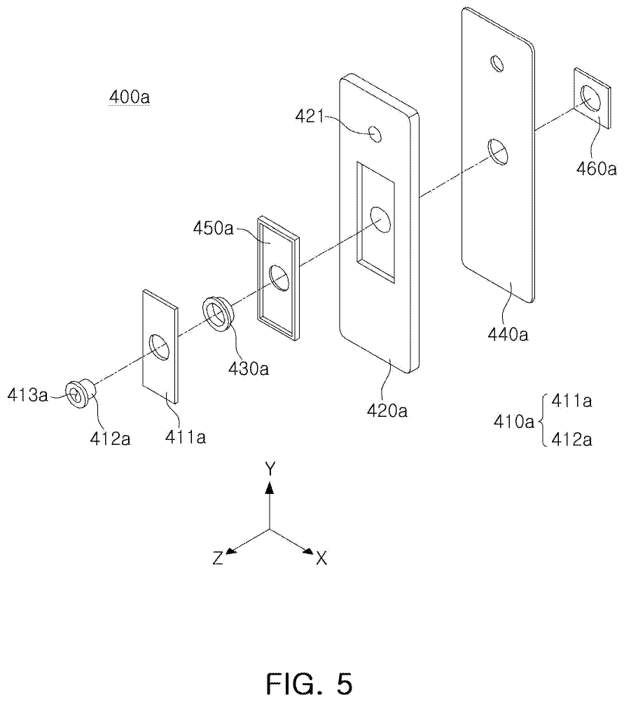

FIG. 5 is an exploded perspective view of the first cap assembly 400a.

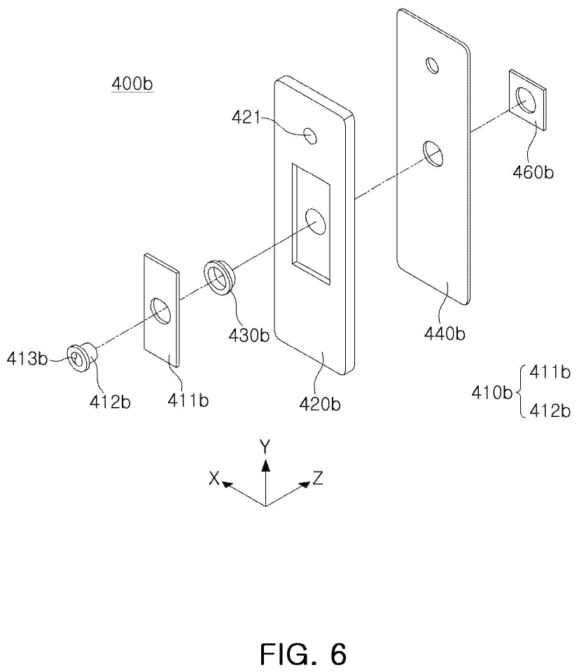

FIG. 6 is an exploded perspective view of a second cap assembly 400b.

The cap assemblies 400a and 400b described in FIGS. 5 and 6 may correspond to the cap assemblies 400a and 400b described in FIGS. 2 to 4, and thus a redundant description thereof may be omitted.

The first cap assembly 400a may include a first terminal 410a electrically connected to an electrode assembly 100 and a first cap plate 420a supporting the first terminal 410a. Furthermore, the first cap assembly 400a may further include a first terminal insulator 450a and a first gasket 430a that electrically separate the first terminal 410a from the first cap plate 420a. Furthermore, the first cap assembly 400a may further include a first cap insulator 440a in which the first cap plate 420a prevents the electrode assembly 100 from being directly short-circuited.

The first terminal 410a of the first cap assembly 400a may include a first terminal portion 411a and a first rivet 412a.

The first terminal portion 411a may be disposed on the first cap plate 420a to serve as a connection terminal in which the battery cell 10 is electrically connected to an external component (e.g., a conductive busbar). To this end, the first terminal portion 411a may be formed of a plate-shaped member formed of a conductive metal such as aluminum or an aluminum alloy. However, the material of the first terminal portion 411a is not limited to aluminum.

The first rivet 412a may be coupled to the first terminal portion 411a. For example, the first rivet 412a may penetrate through the first terminal portion 411a to be riveted and coupled to the first terminal portion 411a. Furthermore, the first rivet 412a and the first terminal portion 411a may be coupled to each other by laser welding.

The first rivet 412a may penetrate through both the first terminal portion 411a and the first cap plate 420a, and an end thereof may be disposed to face one side of the electrode assembly 100.

The first rivet 412a may include a first insertion hole 413a into which a first connection pin 220a of a first connection assembly 200a can be inserted. The first insertion hole 413a may have a shape of a hole penetrating through the first rivet 412a. A connection pin 220 may be inserted into and bonded to the first insertion hole 413a of the first rivet 412a and may be electrically connected to the first rivet 412a.

The first rivet 412a may be formed of a material different from a material constituting the first terminal portion 411a. For example, the first terminal portion 411a may be formed of aluminum or an aluminum alloy, and the first rivet 412a may be formed of copper or a copper alloy. However, the first rivet 412a may be formed of the same material as the material constituting the first terminal portion 411a.

The first cap plate 420a may be coupled to a case 300 to support the first terminal 410a.

The first cap plate 420a may be configured to close a first opening 301 of the case 300. For example, the first cap plate 420a may be formed of a plate-shaped member and may be bonded to the case 300 by laser welding or ultrasonic welding to close the first opening 301. For ease of welding, the first cap plate 420a may be formed of the same material as the case 300. For example, both the first cap plate 420a and the case 300 may be formed of aluminum or an aluminum alloy. However, the material constituting the first cap plate 420a is not limited thereto, and may be formed of any material as long as it can close the first opening 301 of the case 300 and stably protect internal components thereof.

When the first cap plate 420a includes a conductive material, insulating members formed of an insulating material may be disposed between the first terminal 410a and the first cap plate 420a to electrically separate the first terminal 410a from the first cap plate 420a from each other. For example, referring to FIG. 5, the first terminal insulator 450a disposed on a rear surface of the first terminal portion 411a, and the first gasket 430a into which the first rivet 412a is inserted may correspond to such insulating members.

The first terminal insulator 450a may include an insulating material (e.g., a polymer), and may be disposed between the first terminal portion 411a and the first cap plate 420a and may be configured to insulate the first terminal portion 411a from the first cap plate 420a.

The first gasket 430a may include an insulating material (e.g., a polymer), and may be disposed between the first rivet 412a and the first cap plate 420a and may be configured to insulate the first rivet 412a from the first cap plate 420a. On the other hand, the first gasket 430a may be disposed to surround the first rivet 412a, and may block a gap between the first rivet 412a and the first cap plate 420a, thereby preventing foreign materials outside the battery cell 10 from flowing into the gap or an electrolyte inside the battery cell 10 from leaking through the gap.

An insulating member for preventing the first cap plate 420a from being unintentionally short-circuited with a component accommodated in the case 300 (e.g., the electrode assembly 100 or the connection assembly 200) may be disposed on a rear surface of the first cap plate 420a. For example, referring to FIG. 5, in the first cap assembly 400a, the first cap insulator 440a covering the rear surface of the first cap plate 420a may correspond to such an insulation member (here, the ‘rear surface of the first cap plate 420a’ may denote a surface facing from the first cap plate 420a to the internal space S of the case 300). The first cap insulator 440a may include an insulating material to prevent the first cap plate 420a from being short-circuited in contact with the electrode assembly 100 or the connection assembly 200.

The first cap assembly 400a may further include a first fixing member 460a coupled to the first rivet 412a. The first fixing member 460a may be disposed on a rear surface of the first cap plate 420a and may be coupled to an end of the first rivet 412a. The first fixing member 460a may be configured to have a width greater than a hole through which the first rivet 412a passes in the first cap plate 420a. Here, the ‘width’ may denote a length in a direction, perpendicular to the first direction (Z-axis direction), which is a direction in which the first rivet 412a penetrates through the first cap plate 420a. The first fixing member 460a may be coupled to an end of the first rivet 412a penetrating through the first cap assembly 400a, thereby preventing the components constituting the first cap assembly 400a from being separated from each other.

The second cap assembly 400b may include a second terminal 410b electrically connected to the electrode assembly 100 and a second cap plate 420b supporting the second terminal 410b. Furthermore, the second cap assembly 400b may further include a second gasket 430b blocking a gap between a second rivet and the second cap plate 420b. Furthermore, the second cap assembly 400b may further include a second cap insulator 440b for preventing the second cap plate 420b from being directly short-circuited with the electrode assembly 100.

The second terminal 410b of the second cap assembly 400b may include a second terminal portion 411b and a second rivet 412b.

The second terminal portion 411b may be disposed on the second cap plate 420b to serve as a connection terminal used to electrically connect the battery cell 10 to an external component (e.g., a conductive busbar). To this end, the second terminal portion 411b may be formed of a plate-shaped member formed of a conductive metal such as aluminum or an aluminum alloy. However, the material of the second terminal portion 411b is not limited to aluminum.

The second rivet 412b may be coupled to the second terminal portion 411b. For example, the second rivet 412b may penetrate through the second terminal portion 411b to be riveted and coupled to the second terminal portion 411b. Furthermore, the second rivet 412b and the second terminal portion 411b may be coupled to each other by laser welding.

The second rivet 412b may penetrate through both the second terminal portion 411b and the second cap plate 420b, and an end thereof may be disposed to face the electrode assembly 100. In this case, the first rivet 412a may be disposed to face one side of the electrode assembly 100, and the second rivet 412b may be disposed to face the other side opposite to one side of the electrode assembly 100.

The second rivet 412b may include a second insertion hole 413b into which a second connection pin 220b of a second connection assembly 200b can be inserted. The second insertion hole 413b may have a shape of a hole penetrating through the second rivet 412b. The connection pin 220 may be inserted into and bonded to the second insertion hole 413b of the second rivet 412b and may be electrically connected to the second rivet 412b.

The second rivet 412b may be formed of the same material as a material constituting the second terminal portion 411b. For example, both the second terminal portion 411b and the second rivet 412b may be formed of aluminum or an aluminum alloy. However, if necessary, the second rivet 412b may be formed of a material different from the material constituting the second terminal portion 411b.

The second cap plate 420b may be coupled to the case 300 to support the second terminal 410b.

The second cap plate 420b may be configured to close a second opening 302 of the case 300. For example, the second cap plate 420b is formed of a plate-shaped member and may be bonded to the case 300 by laser welding or ultrasonic welding to close the second opening 302. For ease of welding, the second cap plate 420b may be formed of the same material as the case 300. For example, both the second cap plate 420b and the case 300 may be formed of aluminum or an aluminum alloy. However, the material constituting the second cap plate 420b is not limited thereto, and may be formed of any material as long as it can close the second opening 302 of the case 300 and stably protect internal components thereof.

The second gasket 430b may be disposed between the second rivet 412b and the second cap plate 420b, and may block a gap between the second rivet 412b and the second cap plate 420b, thereby preventing foreign materials outside the battery cell 10 from flowing into the gap or an electrolyte inside the battery cell 10 from leaking through the gap. Furthermore, the second gasket 430b may include an insulating material (e.g., a polymer).

Although not illustrated in the drawings, a second terminal insulator for electrically separating the second terminal portion 411b from the second cap plate 420b may be disposed between the second terminal portion 411b and the second cap plate 420b. However, in some embodiments, when the second terminal portion 411b and the second cap plate 420b do not need to be insulated from each other, the second terminal insulator may be omitted as illustrated in FIG. 6, and in this case, the second terminal portion 411b and the second cap plate 420b may be in contact with each other.

An insulating member for preventing the second cap plate 420b from being unintentionally short-circuited with a component accommodated in the case 300 (e.g., the electrode assembly 100 or the connection assembly 200) may be disposed on a rear surface of the second cap plate 420b. For example, referring to FIG. 6, in the second cap assembly 400b, the second cap insulator 440b covering the rear surface of the second cap plate 420b may correspond to such an insulating member. (Here, the ‘rear surface of the second cap plate 420b’ may denote a surface facing from the second cap plate 420b to the internal space S of the case 300. The second cap insulator 440b may include an insulating material to prevent the second cap plate 420b from being short-circuited in contact with the electrode assembly 100 or the connection assembly 200.

The second cap assembly 400b may further include a second fixing member 460b coupled to the second rivet 412b. The second fixing member 460b may be disposed on a rear surface of the second cap plate 420b and may be coupled to an end of the second rivet 412b. The second fixing member 460b may be configured to have a width greater than a hole through which the second rivet 412b passes in the second cap plate 420b. Here, the ‘width’ may denote a length in a direction, perpendicular to the first direction (Z-axis direction), which is a direction in which the second rivet 412b penetrates through the second cap plate 420b. The second fixing member 460b may be coupled to an end of the second rivet 412b penetrating through the second cap assembly 400b, thereby preventing the components constituting the second cap assemblies 400b from being separated from each other.

At least one of a plurality of cap assemblies 400a and 400b may include an electrolyte inlet 421 used to inject an electrolyte into the case 300. For example, referring to FIGS. 5 and 6, each of the first cap assembly 400a and the second cap assembly 400b may include the electrolyte inlet 421.

The electrolyte inlet 421 may be provided on the cap plates 420a and 420b. After injecting the electrolyte, the electrolyte inlet 421 is sealed with a stopper to prevent the electrolyte from leaking out of the battery cell 10.

The electrolyte inlet 421 may be provided in both the first cap assembly 400a and the second cap assembly 400b, or may be provided in only one cap assembly.

In some embodiments, the first cap plate 420a, the first terminal portion 411a, the second cap plate 420b, and the second terminal portion 411b may be all formed of the same material, and in this case, the case 300 may also be formed of the same material.

The first terminal 410a of the first cap assembly 400a and the second terminal 410b of the second cap assembly 400b may be configured to have different polarities. For example, in the battery cell 10, the first terminal 410a may be electrically connected to negative pole plates, and the second terminal 410b may be electrically connected to positive pole plates. (Or vice versa.)

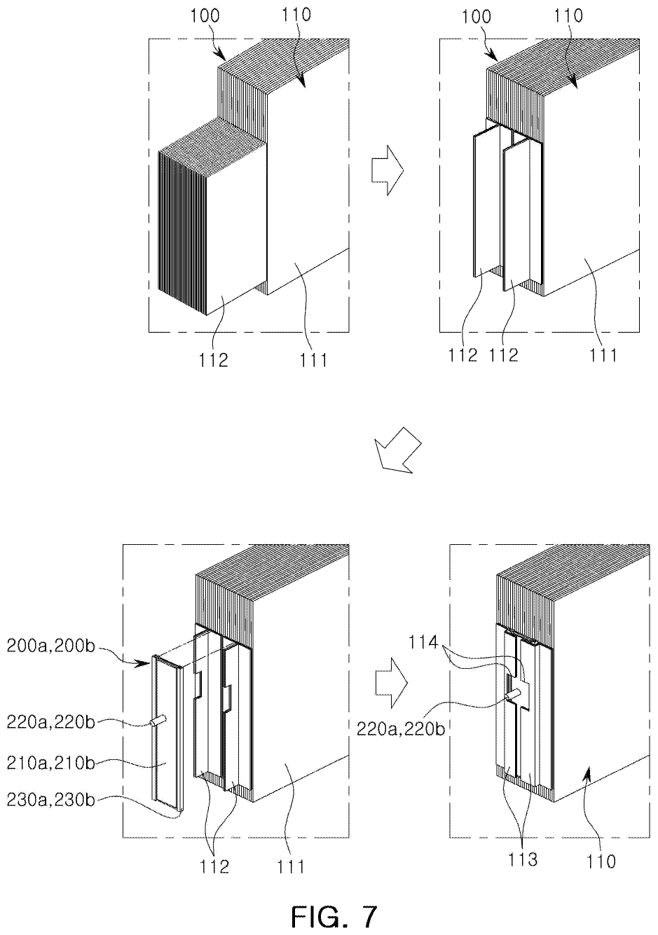

FIG. 7 is a view exemplarily illustrating a state in which an electrode assembly 100 and a connection assembly 200 are coupled to each other.

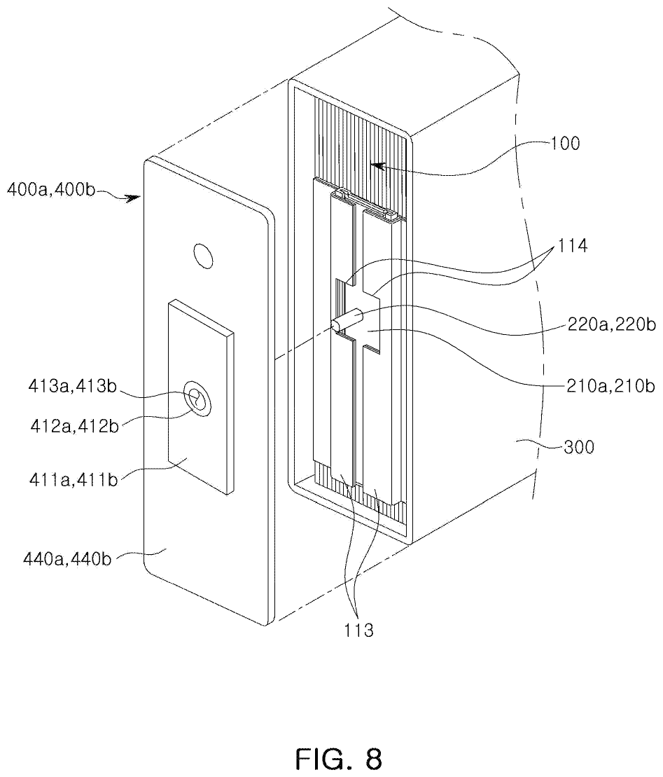

FIG. 8 is a view exemplarily illustrating a state in which a cap assembly 400 is coupled to a case 300.

A battery cells 10 and components thereof described in FIGS. 7 and 8 correspond to the battery cell 10 and the components thereof described in FIGS. 2 to 6, and thus a redundant description thereof may be omitted.

FIG. 7 may sequentially illustrate a process in which an electrode assembly 100 and a connection assembly 200 are connected to each other, during the manufacturing process of the battery cell 10.

Referring to an upper left end of FIG. 7, the electrode assembly 100 may include a plurality of polar plates 110 stacked in one direction. At least one of the plurality of polar plates 110 may include a coated portion 111 coated with an active material and an uncoated portion 112 not coated with the active material. In the process of stacking or winding the plurality of polar plates, the uncoated portions 112 may be aligned side by side in a predetermined position.

The uncoated portion 112 may be electrically connected to terminals 410a and 410b of cap assembly 400a and 400b through the connection assembly 200 to form a path for current flow between the electrode assembly 100 and the terminals 410a and 410b.

In the electrode assembly 100, the uncoated portions 112 may be configured to extend from one side of the portion 111. In this case, the uncoated portions of the positive pole plate may be disposed side by side on one side of the electrode assembly 100, and the uncoated portions of the negative pole plate may be disposed side by side on the other side opposite to one side of the electrode assembly 100. For example, all of the uncoated portions 112 illustrated at the upper left end of FIG. 7 may have the same polarity.

Referring to an upper right end of FIG. 7, the uncoated portions 112 having the same polarity may be in contact with and connected to each other. If necessary, at least a portion of the uncoated portions 112 may be folded or bent to come into contact with other neighboring uncoated portions 112.

Referring to the lower left of FIG. 7, the uncoated portions 112 having the same polarity may be bound to each other to form a plurality of aggregates, and connection assemblies 200a and 200b may be seated between the aggregates and may be electrically connected to the uncoated portions 112.

The connection assemblies 200a and 200b may include current collecting members 210a and 210b electrically connected to the uncoated portion 112, connection pins 220a and 220b protruding from the current collecting members 210a and 210b, and insulating members 230a and 230b surrounding a rear surface of the current collecting members 210a and 210b. Here, the rear surface of the current collecting members 210a and 210b may refer to a surface facing the electrode assembly 100 as a surface opposite to the direction in which the connection pin 220 protrudes from the current collecting members 210a and 210b.

The current collecting members 210a and 210b are plate-shaped members including conductive metals and may be electrically connected to the uncoated portion 112 of the electrode assembly 100 to form a path for current flow between the electrode assembly 100 and a terminal 410.

The connection pin 220 may be configured to protrude from one surface of the current collecting members 210a and 210b to an external periphery of the electrode assembly 100. For example, the connection pin 220 may protrude from one surface of the current collecting members 210a and 210b in a first direction, that is, a direction in which the cap assembly 400 is assembled.

The insulating members 230a and 230b may include an insulating material and may be disposed between the current collecting members 210a and 210b and the uncoated portion 112. The current collecting members 210a and 210b may be in contact with the uncoated portion 112 through a portion that is not covered by the insulating members 230a and 230b. The insulating members 230a and 230b surround a partial surface of the current collecting members 210a and 210b to allow the current collecting members 210a and 210b to be connected to the uncoated portion 112 only in a specific portion thereof.

Referring to a right lower end of FIG. 7, at least a portion of the uncoated portion 112 may be bent to form a bent portion 113, and the bent portion 113 may cover at least a portion of a front surface of the current collecting members 210a and 210b. Here, the front surface of the current collecting members 210a and 210b is a surface opposite to the rear surface of the current collecting members 210a and 210b, and may refer to a surface in a direction in which the connection pin 220 protrudes.

The bent portion 113 of the uncoated portion 112 and the current collecting members 210a and 210b may be electrically connected to each other. For example, the bent portion 113 of the uncoated portion 112 and the current collecting members 210a and 210b may come into contact with each other and may be welded and electrically connected to each other.

A welding process may be performed through a front surface of the bent portion 113 in a state in which the bent portion 113 covers the front surface of the current collecting members 210a and 210b. In this case, the current collecting members 210a and 210b may be disposed on a rear surface of the bent portion 113, thereby preventing damage from being applied to an interior of the electrode assembly 100 by the welding process.

The uncoated portion 112 of the electrode assembly 100 may include an avoiding portion 114 to avoid interference with the connection pins 220a and 220b. For example, referring to FIG. 7, a portion of the uncoated portion 112 may be cut to form the avoiding portion 114, thereby avoiding the interference with the connection pins 220a and 220b in the process of bending the uncoated portion 112 to cover at least a portion of the connection assemblies 200a and 200b.

The electrode assembly 100 that is completely connected to the connection assemblies 200a and 200b may be accommodated in the case 300 and may be electrically connected to terminals 410a and 410b of the cap assemblies 400a and 400b. For example, referring to FIG. 8, in a state in which the electrode assembly 100 is accommodated in the case 300, the cap assemblies 400a and 400b may be assembled in the case 300, and in this process, the connection pin 220 may be inserted into the terminals 410a and 410b of the cap assemblies 400a and 400b. Accordingly, the electrode assembly 100 may be electrically connected to the current collecting members 210a and 210b, the connection pins 220a and 220b, and the terminals 410a and 410b.

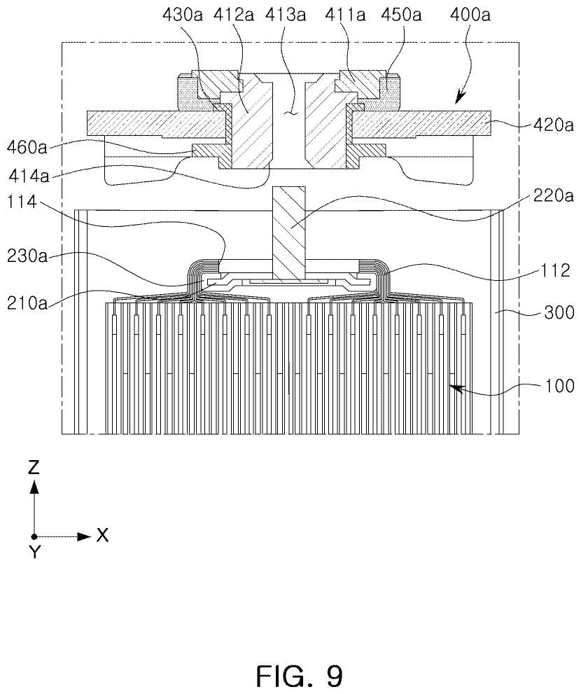

FIG. 9 is a view illustrating an example in which a first cap assembly 400a is coupled to a case 300.

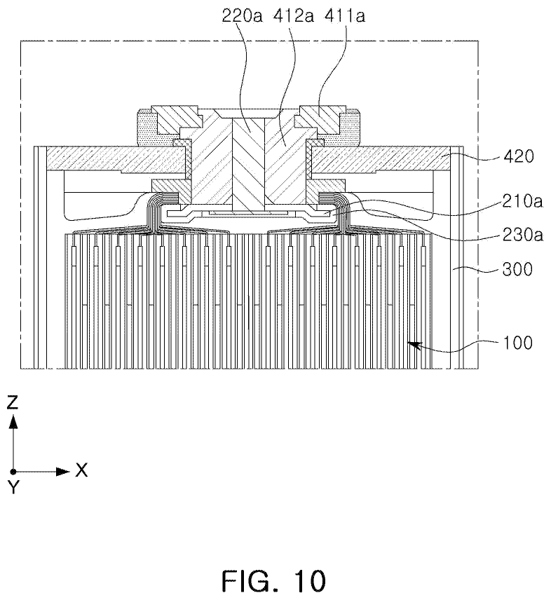

FIG. 10 is a partial cross-sectional view of a battery cell 20 according to some embodiments.

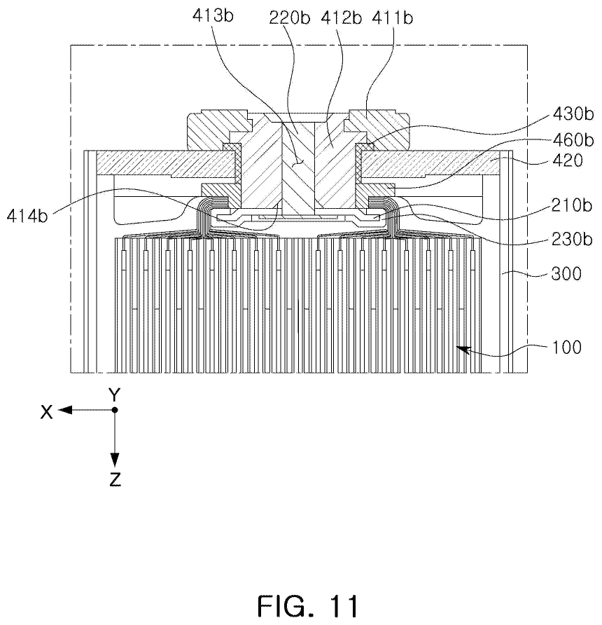

FIG. 11 is a partial cross-sectional view of a battery cell 10 according to some embodiments.

Since a battery cell 10 and components thereof described in FIGS. 9 to 11 correspond to the battery cells 10 and the components thereof described in FIGS. 2 to 8, a redundant description thereof may be omitted.

Referring to FIGS. 9 and 10, a first cap assembly 400a of the battery cell 10 may be coupled to the case 300 in a first direction (Z-axis direction), and accordingly, a first terminal 410a of the first cap assembly 400a may be electrically connected to an electrode assembly 100 through a first connection assembly 200a.

The first connection assembly 200a may include a first current collecting member 210a electrically connected to an uncoated portion 112 of the electrode assembly 100, a first connection pin 220a coupled to a first current collecting member 210a, and a first insulating member 230a surrounding a portion of the first current collecting member 210a.

The first connection pin 220a may be configured to penetrate through the first current collecting member 210a and extend in a direction oriented toward the first cap assembly 400a.

The first connection pin 220a may be provided as a separate member assembled to the first current collecting member 210a, or may be integrally provided with the first current collecting member 210a.

The first current collecting member 210a and the first connection pin 220a may be formed of the same material as a material constituting the uncoated portion 112 connected to the first current collecting member 210a. For example, when the uncoated portion 112 connected to the first current collecting member 210a is formed of copper or a copper alloy, the first current collecting member 210a and the first connection pin 220a may be formed of the same copper or a copper alloy as described above.

However, the material of the first current collecting member 210a and the first connection fin 220a is not limited to the aforementioned description, and may be formed of, for example, a material different from the uncoated portion 112 connected to the first current collecting member 210a.

The first insulating member 230a may include an insulating material and may be disposed between the first current collecting member 210a and the uncoated portion 112. The first current collecting member 210a may be in contact with the uncoated portion 112 through a portion that is not covered by the first insulating member 230a. The first insulating member 230a may be surround a partial surface of the first current collecting member 210a to allow the first current collecting member 210a to be connected to the uncoated portion 112 only in a specific portion thereof.

A first terminal 410a of the first cap assembly 400a may be electrically connected to the first connection pin 220a.

The first terminal 410a may include a first terminal portion 411a exposed to an external periphery of the first cap assembly 400a, and a first rivet 412a coupled to the first terminal portion 411a.

The first rivet 412a may include a first insertion hole 413a into which the first connection pin 220a is inserted. The first connection pin 220a may be welded and coupled to the first insertion hole 413a while being inserted into the first insertion hole 413a. For example, referring to FIG. 10, in a state in which the first connection pin 220a may be inserted into the first insertion hole 413a, an upper end thereof may be exposed to the outside of the battery cell 10, and through the upper end, a contact portion between the first connection pin 220a and the first rivet 412a may be welded and bonded to each other.

A width of the first insertion hole 413a may have a size corresponding to a thickness of the first connection pin 220a.

The first rivet 412a may further include a first guide groove 414a for guiding an insertion position of the first connection pin 220a. For example, the first guide groove 414a may have a shape of an inclined surface formed at an inlet of the first insertion hole 413a. Accordingly, even if the first insertion hole 413a has a size that fits the first connection pin 220a, an upper end of the first connection pin 220a may easily enter the first insertion hole 413a along the inclined surface of the first guide groove 414a, thereby increasing assembly easiness.

An end of the first rivet 412a may be inserted into an avoiding portion 114 provided to avoid the first connection pin 220a from the uncoated portion 112. For example, referring to FIG. 10, the end of the first rivet 412a may be disposed adjacent to the first current collecting member 210a exposed through the avoiding portion 114 in a state in which the first cap assembly 400a is coupled to the case 300. According to such a structure, the first cap assembly 400a and the electrode assembly 100 may be brought into close contact with each other to increase space efficiency.

In some embodiments, a material constituting the first rivet 412a and a material constituting the first terminal portion 411a may be different from each other. For example, the first terminal portion 411a may include aluminum, and the first rivet 412a may include copper or may be formed in a form in which nickel is plated on copper.

In this case, the material constituting the first rivet 412a may be the same as a material constituting the first connection pin 220a inserted into the first rivet 412a. For example, when the first connection pin 220a includes copper, the first rivet 412a may also include copper. As the first rivet 412a and the first connection pin 220a are formed of the same material, coupling easiness and bonding reliability by means of welding between the first rivet 412a and the first connection pin 220a may be further increased.

Specifically, since the first connection pin 220a is connected to the first terminal portion 411a through the first rivet 412a formed of the same material, the coupling easiness and coupling reliability may be increased as compared to a case in which the first connection pin 220a is directly coupled to the first terminal portion 411a formed of a heterogeneous material.

In other words, the first rivet 412a directly connected to the first connection pin 220a may be formed of the same material as the first connection pin 220a, and the first terminal portion 411a may be formed of a material different from the first rivet 412a and the first connection pin 220a, thereby ensuring the connection easiness and connection stability as well as increasing a degree of freedom of a material selection of a terminal 410.

Referring to FIG. 11, a second terminal 410b of a second cap assembly 400b of the battery cell 10 may be electrically connected to the electrode assembly 100 through a second connection assembly 200b.

The second connection assembly 200b may include a second current collecting member 210b electrically connected to an uncoated portion 112 of the electrode assembly 100, a second connection pin 220b coupled to the second current collecting member 210b, and a second insulating member 230b surrounding a portion of the second current collecting member 210b.

The second connection pin 220b may be configured to extend in a direction oriented toward the second cap assembly 400b by penetrating through the second current collecting member 210b.

The second connection pin 220b may be provided as a separate member assembled to the second current collecting member 210b, or may be provided integrally with the second current collecting member 210b.

The second current collecting member 210b and the second connection pin 220b may be formed of the same material as a material constituting the uncoated portion 112 connected to the second current collecting member 210b. For example, when the uncoated portion 112 connected to the second current collecting member 210b is formed of aluminum or an aluminum alloy, the second current collecting member 210b and the second connection pin 220b may be formed of the same aluminum or an aluminum alloy described above.

However, a material of the second current collecting member 210b and the second connection fin 220b is not limited to the aforementioned description, and the second current collecting member 210b and the second connection fin 220b may be formed of, for example, a material different from the uncoated portion 112 connected to the second current collecting member 210b.

The second insulating member 230b may include an insulating material and may be disposed between the second current collecting member 210b and the uncoated portion 112. The second current collecting member 210b may be in contact with the uncoated portion 112 through a portion that is not covered by the second insulating member 230b. The second insulating member 230b may surround a partial surface of the second current collecting member 210b to allow the second current collecting member 210b to be connected to the uncoated portion 112 only in a specific portion thereof.

The second terminal 410b of the second cap assembly 400b may be electrically connected to the second connection pin 220b.

The second terminal 410b may include a second terminal portion 411b exposed to the outside of the second cap assembly 400b and a second rivet 412b coupled to the second terminal portion 411b.

The second rivet 412b may include a second insertion hole 413b into which the second connection pin 220b is inserted. The second connection pin 220b may be welded and coupled to the second insertion hole 413b while being inserted into the second insertion hole 413b. For example, referring to FIG. 11, in a state in which the second connection pin 220b may be inserted into the second insertion hole 413b, an upper end thereof may be exposed to the outside of the battery cell 10, and through the upper end, a contact portion between the second connection pin 220b and the second rivet 412b may welded and bonded to each other.

A width of the second insertion hole 413b may have a size corresponding to a thickness of the second connection pin 220b.

The second rivet 412b may further include a second guide groove 414b for guiding an insertion position of the second connection pin 220b. For example, the second guide groove 414b may have a shape of an inclined surface formed at an inlet of the second insertion hole 413b. Accordingly, even if the second insertion hole 413b has a size that fits the second connection pin 220b, the upper end of the second connection pin 220b may easily enter the second insertion hole 413b along the inclined surface of the second guide groove 414b, thereby increasing assembly easiness.

An end of the second rivet 412b may be inserted into an avoiding portion 114 provided to avoid the second connection pin 220b in the uncoated portion 112. For example, referring to FIG. 11, in a state in which the second cap assembly 400b is coupled to the case 300, the end of the second rivet 412b may be disposed adjacent to the second current collecting member 210b exposed through the avoiding portion 114. According to such a structure, the second cap assembly 400b and the electrode assembly 100 may be brought into close contact with each other to increase space efficiency.

In some embodiments, a material constituting the second rivet 412b and a material constituting the second terminal portion 411b may be identical to each other. However, if necessary, the material constituting the second rivet 412b and the material constituting the second terminal portion 411b may be different from each other.

A material constituting the second rivet 412b may be the same as a material constituting the second connection pin 220b inserted into the second rivet 412b. For example, when the second connection pin 220b includes aluminum or an aluminum alloy, the second rivet 412b may also include aluminum or an aluminum alloy. As the second rivet 412b and the second connection pin 220b are formed of the same material, coupling easiness and bonding reliability by means of welding between the second rivet 412b and the second connection pin 220b may be further increased.

In some embodiments, the first terminal 410a of the first cap assembly 400a and the second terminal 410b of the second cap assembly 400b may be configured to have different polarities. For example, the first terminal 410a illustrated in FIG. 10 may be a negative pole terminal, and the second terminal 410b illustrated in FIG. 11 may be a positive pole terminal.

In some embodiments, the battery cell 10 may include both the first cap assembly 400a and the second cap assembly 400b described above, or may include only either of them.

For example, the battery cell 10 may include both the first cap assembly 400a and the second cap assembly 400b, and the positive pole terminal may be implemented by the first terminal 410a and the negative pole terminal may be implemented by the second terminal 410b. Alternatively, the battery cell 10 may include only the first cap assembly 400a, and the negative pole terminal may be implemented by the first terminal 410a, but the positive pole terminal may be implemented through the structure illustrated in FIG. 1. Alternatively, the battery cell 10 may include only the second cap assembly 400b, and the positive pole terminal may be implemented by the second terminal 410b, but the negative pole terminal may be implemented through the structure illustrated in FIG. 1.

The battery cell 10 according to some embodiments may stably connect the electrode assembly 100 to the terminals 410a and 410b through the connection pins 220a and 220b of the connection assemblies 200a and 200b. Furthermore, in the battery cell 10, since at least a portion of the connection pins 220a and 220b are inserted into the terminals 410a and 410b, a wasted space for a connection between the electrode assembly 100 and the terminals 410a and 410b may be reduced, so that it is advantageous to increase energy density.

Furthermore, since an electrical connection between the terminal 410 and the electrode assembly 100 is naturally performed through the connection pins 220a and 220b in the process of attaching the cap assembly 400 to the case 300, an assembly process of the battery cell 10 may be further simplified.

Meanwhile, at least one battery cell 10 described above may be stacked and provided in a battery module 30 or a battery pack 50. The battery cells 10 according to embodiments may be provided in the battery module 30 in a sequential stacked form, and the battery module 30 may be provided in the battery pack 50.

That is, the battery module 30 according to the embodiment of the disclosed technology may include the battery cell 10 according to the above-described embodiments, and the battery pack 50 according to an embodiment of the disclosed technology disclosure may include the battery module 30.

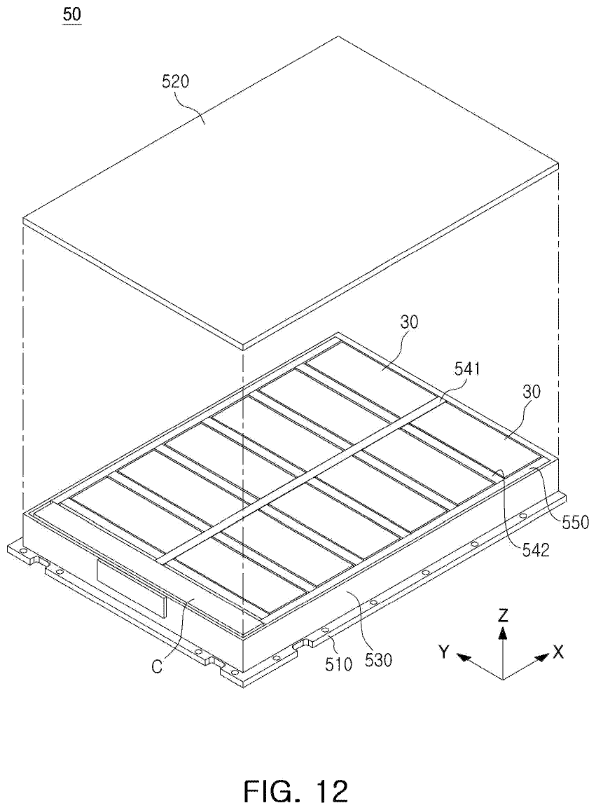

FIG. 12 is a perspective view of a battery module including a battery cell and a battery pack according to some embodiments.

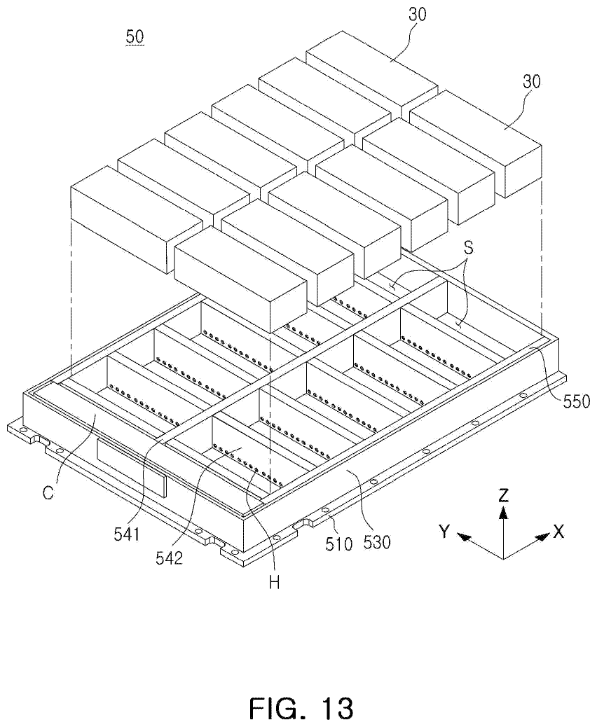

FIG. 13 is a perspective view illustrating a state in which a battery module is separated from FIG. 12.

Referring to FIGS. 12 and 13, one or more battery cells 10 according to the above-described embodiments may be sequentially stacked in a battery module 30 according to an embodiment of the disclosed technology in a thickness direction (X-axis direction). A battery pack 50 may be provided with an accommodation space S to accommodate the battery module 30.

The battery pack 50 may include a bottom member 510 supporting a bottom surface of the battery module 30, a cover member 520 covering a top surface of the battery module 30, and a sidewall member 530 connecting the bottom member 510 and the cover member 520.

The battery pack 50 may include partition walls 541 and 542 crossing at least a portion of the accommodation space S. For example, the accommodation space S may be divided into a plurality of spaces by partition walls 541 and 542. The partition walls 541 and 542 may be installed across the accommodation space S in order to reinforce the rigidity of the battery pack 50.

In an embodiment, the partition walls 541 and 542 may include a first partition wall 541 and a second partition wall 542 vertically arranged with respect to each other. In an embodiment, at least a portion of the partition walls 541 and 542 may include a venting hole H for inducing a path of gas and/or flames generated from the battery cell 10 or the battery module 30.

In an embodiment, the battery pack 50 may include a duct member 550. A flow space through which gas and/or flames discharged from the battery cell 10 or the battery module 30 flows may be formed inside the duct member 550. The duct member 550 may be disposed inside the battery pack 50. The flow space of the duct member 550 may be connected to the venting hole H of the second partition wall 542. For example, gas and/or flames generated in the battery cell 10 or the battery module 30 may be transmitted to the outside of the battery pack 50 through the venting hole H of the second partition 542 and the flow space of the duct member 550.

Furthermore, the battery pack 50 may include a battery controller C for controlling the battery cell 10 and/or the battery module 30. The battery controller C may be disposed inside the battery pack 50. The battery controller C may include a battery management system (BMS). The configuration of the battery controller C is known in various forms, and thus a detailed description thereof will be omitted. In an embodiment, the battery controller C may be referred to as a processor.

Meanwhile, the structures of the battery module 30 and the battery pack 50 described above are exemplary. For example, in FIGS. 12 and 13, the battery pack 50 has been described as accommodating the battery module 30 including the battery cell 10 according to the above-described embodiments, but the battery pack 50 of the disclosed technology may include the battery cell 10 therein. In other words, a case in which a plurality of battery cells 10 according to some embodiments are directly stacked in an accommodation space S sequentially may also be considered to belong to the battery pack 50 according to an embodiment of the disclosed technology.

The content described above is merely an example in which the principle of the disclosed technology is applied, and other configurations may be further included without departing from the scope of the disclosed technology. Therefore, it will be apparent to those skilled in the art that modifications and variations could be made without departing from the scope of the disclosed technology as defined by the appended claims. In addition, some components may be deleted and implemented in the above-described example embodiments, and each of the embodiments may be combined and implemented with each other.

What is claimed is:

1. A battery cell comprising:
an electrode assembly in which a plurality of polar plates are stacked;
a case having an internal space in which the electrode assembly is accommodated;
a cap assembly coupled to the case and having a terminal disposed therein; and
a connection pin configured to electrically connect the electrode assembly and the terminal,
wherein the terminal comprises:
a rivet having an insertion hole into which the connection pin is inserted; and
a terminal portion coupled to the rivet.

2. The battery cell of claim 1, wherein the terminal portion and the rivet are formed of different materials.

3. The battery cell of claim 2, wherein the rivet and the connection pin are formed of the same material.

4. The battery cell of claim 1, wherein the cap assembly further comprises:
a cap plate coupled to at least one side of the case to support the terminal portion; and
a sealing member disposed between the cap plate and the rivet.

5. The battery cell of claim 4, wherein the cap assembly further comprises:
a first insulating member disposed between the cap plate and the terminal portion.

6. The battery cell of claim 1, further comprising:
a current collecting member electrically connected to the connection pin,
wherein the electrode assembly further includes an uncoated portion electrically connected to the current collecting member.

7. The battery cell of claim 6, wherein the uncoated portion includes a bent portion in contact with the current collecting member, and
the bent portion is disposed between the current collecting member and the terminal.

8. The battery cell of claim 7, wherein the bent portion includes an avoiding portion for avoiding the connection pin.

9. The battery cell of claim 8, wherein an end of the rivet is inserted into the avoiding portion.

10. The battery cell of claim 1, wherein the rivet includes a guide groove for guiding an insertion position of the connection pin.

11. The battery cell of claim 1, wherein an end of the connection pin is exposed to the outside of the cap assembly through the insertion hole.

12. A battery cell comprising:
a case including a first opening and a second opening spaced apart from the first opening;
an electrode assembly accommodated in the case;
a first cap assembly coupled to the first opening and including a first terminal;
a second cap assembly coupled to the second opening and including a second terminal; and
a first connection pin configured to electrically connect the first terminal and the electrode assembly.

13. The battery cell of claim 12, wherein the first terminal comprises:
a first rivet having a first insertion hole into which the first connection pin is inserted; and
a first terminal portion coupled to the first rivet.

14. The battery cell of claim 13, wherein the first cap assembly comprises:
a first cap plate coupled to the first opening of the case above to support the first terminal portion; and
a first insulating member configured to electrically separate the first cap plate from the first terminal portion.

15. The battery cell of claim 13, further comprising:
a second connection pin configured to electrically connect the second terminal and the electrode assembly,
wherein the second terminal comprises:
a second rivet having a second insertion hole into which the second connection pin is inserted; and
a second terminal portion coupled to the second rivet.

16. The battery cell of claim 15, wherein the first connection pin and the second connection pin are formed of different materials,
the first rivet includes the same material as that of the first connection pin, and
the second rivet includes the same material as that of the second connection pin,
wherein the first terminal portion and the second terminal portion are formed of the same material.

17. The battery cell of claim 15, wherein the second cap assembly further comprises:
a second cap plate coupled to the second opening of the case to support the second terminal portion,
wherein the second terminal portion is in contact with the second cap plate.

18. The battery cell of claim 15, wherein the first connection pin and the second connection pin are welded and coupled to the first rivet and the second rivet, respectively.

19. The battery cell of claim 12, wherein the first cap assembly is coupled to one side of the case, and the second cap assembly is coupled to the other side, opposite to the one side of the case.

20. A battery pack comprising:
at least one battery cell,
wherein the battery cell comprises:
an electrode assembly in which a plurality of polar plates are stacked;
a case having an internal space in which the electrode assembly is accommodated;
a cap assembly coupled to the case and having a terminal disposed therein; and
a connection pin configured to electrically connect the electrode assembly and the terminal,
wherein the terminal comprises:
a rivet having an insertion hole into which the connection pin is inserted; and
a terminal portion coupled to the rivet.
